(19) United States
(12) Patent Application Publication
(10) Pub. No.: US 2025/0184886 A1
(43) Pub. Date: Jun. 5, 2025

(54) METHOD FOR DETERMINING VARIABLE IN ROUTING BASED ON DETERMINISTIC CLUSTER

(71) Applicant: UNIVERSITY OF SEOUL INDUSTRY COOPERATION FOUNDATION, Seoul (KR)

(72) Inventor: Sang Hyuk KANG, Seoul (KR)

(21) Appl. No.: 18/959,814

(22) Filed: Nov. 26, 2024

(30) Foreign Application Priority Data
Dec. 1, 2023 (KR) 10-2023-0172766

(51) Int. Cl. H04W 52/02; H04B 17/10; H04W 4/38

(52) U.S. Cl. CPC H04W 52/0206; H04B 17/102; H04W 4/38

(57) ABSTRACT

The disclosed embodiment provides a technology for determining optimized variables in routing based on deterministic cluster. Existing technologies only optimize the number of clusters in stochastic-based routing, so there is a limitation in optimizing variables in routing based on deterministic cluster. In the disclosed embodiment, the amount of energy consumed by the head node and the member nodes may be calculated using a mathematical equation that uses the number of clusters as a variable to derive the optimum number of clusters that minimizes the sum thereof. In addition, in the disclosed embodiment, the most efficient formation of clusters may be determined based on the maximum density packing method. Thus, the disclosed embodiment may maximize the lifespan of a wireless network by maximizing energy efficiency through optimization of variables. Therefore, the present invention has superior competitiveness compared to existing technologies.

### CROSS-REFERENCE TO RELATED APPLICATION

This application is based on and claims priority under 35 U.S.C. § 119 to Korean Patent Application No. 10-2023-0172766, filed on Dec. 1, 2023, in the Korean Intellectual Property Office, the disclosure of which is incorporated by reference herein in its entirety.

### TECHNICAL FIELD

Disclosed embodiments relate to techniques for determining variables that optimize energy efficiency in deterministic cluster routing in wireless sensor networks. Specifically, the disclosed embodiments relate to techniques for optimizing the number of clusters and the formation of clusters as variables that affect energy efficiency in cluster routing.

### BACKGROUND ART

A wireless sensor network (WSN) obtains target information from data transmitted by multiple nodes placed in a sensor field. Since each node receives energy from a battery, the energy consumed in data transmission must be minimized.

Particularly, in the case of a cluster routing method, the amount of consumed energy varies, largely depending on two variables. The two representative variables include the number of clusters for dividing the area of the sensor field and the formation of clusters for dividing the cluster into a certain form.

In this regard, the low energy adaptive clustering hierarchy (LEACH) protocol was proposed as an energy-saving method. However, the LEACH protocol only estimates the optimum number of clusters in each round based on probability.

In addition, the LEACH protocol is a non-deterministic cluster method. That is, although the location of every node is detected through the deterministic cluster method, research for analyzing variables that save energy efficiency is lacking.

### PRIOR ART DOCUMENT

Patent Document: Korean Patent Publication No. 10-1780144 (published on Sep. 19, 2017)

### DISCLOSURE OF INVENTION

### Technical Problem

Disclosed embodiments provide a method for determining variables in routing based on deterministic cluster, and particularly, for determining the number of clusters and the formation of clusters to optimize energy efficiency in deterministic cluster-based routing. The method may derive the optimum number of clusters and the formation of clusters as variables that affect the energy usage of nodes in deterministic cluster-based routing and may maximize the lifespan of wireless sensor networks, compared to existing stochastic cluster-based routing which has a completely different algorithm.

### Solution to Problem

According to an embodiment, a method for determining variables in routing based on deterministic cluster comprises deriving energy, which is consumed by K head nodes among N sensor nodes distributed in a circular sensor field divided into K cluster regions, as a first function with K as a variable, deriving energy, which is consumed by the other N−K member nodes than the K head node among the N sensor nodes, as a second function with the K as a variable, and calculating a value of K from poles of a third function derived based on the first function and the second function.

The N sensor nodes may be evenly distributed in each of the K cluster regions.

The deriving of the first function may include deriving first energy, which is consumed by each of the K head nodes receiving sensing data from the N−K member nodes, as a first energy function with K as a variable, deriving second energy, which is consumed by each of the K head nodes converting the sensing data into the aggregate data, as a second energy function with K as a variable, deriving third energy, which is consumed by each of the K head nodes transmitting the aggregate data to a base station node located at the border of the circular sensor field, as a third energy function with K as a variable, and deriving the first function by adding the first energy function, the second energy function, and the third energy function.

The deriving of the first energy function may include deriving first energy, which is consumed by each of the K head nodes receiving bit-unit sensing data from the member nodes, as the first energy function based on the Equation 1 below:

$${E}_{CH \_ E 1} = {\sum }_{i = 1}^{K} {E}_{i , {CH}_{E 1}} = K * {l}_{d} * ( \frac{N}{K} - 1 ) * {E}_{e} \qquad [ Equation 1 ]$$

E_{CH_E1} may refer to the first energy function, E_{i,CH}_{_{E1}} may refer to the first energy consumed by the head node of the i^{th} cluster, l_{d} may refer to a bit length of the sensing data, Eₑ may refer to a preset value, K may refer to the number of clusters or head nodes, and N may refer to the number of sensor nodes.

The deriving of the second energy function may include deriving second energy, which is consumed by each of the K head nodes converting the sensing data into the aggregate data, as the second energy function based on Equation 2 below:

$${E}_{CH \_ E 2} = {\sum }_{i = 1}^{K} {E}_{i , {CH}_{E 2}} = {l}_{d} * {E}_{DA} * ( \frac{N}{K} ) \qquad [ Equation 2 ]$$

E_{CH_E2} may refer to the second energy function, E_{i,CH}_{_{E2}} may refer to the second energy consumed by the head node of the i^{th} cluster, l_{d} may refer to a bit length of the sensing data, E_{DA} may refer to a preset value, K may refer to the number of clusters or head nodes, and N may refer to the number of sensor nodes.

The deriving of the third energy function may include deriving third energy, which is consumed by each of the K head nodes transmitting the aggregate data to the base station node located at the border of the circular sensor field, as a third energy function based on Equation 3 below:

$$\{ \begin{matrix}{E}_{CH \_ E 3} = {\sum }_{i = 1}^{K} {E}_{i , {CH}_{E 3}} = K * {l}_{d} * ( {E}_{e} + {ε}_{f} * \overline{{d}_{toBS}^{2}} ) \\ \overline{{d}_{toBS}^{2}} = \frac{3}{2} {L}^{2}\end{matrix} \qquad [ Equation 3 ]$$

E_{CH_E3} may refer to the third energy function, E_{i,CH}_{_{E3}} may refer to the third energy consumed by the head node of the i^{th} cluster, la may refer to a bit length of the sensing data, Eₑ may refer to a preset first value, ε_{f} may refer to a preset second value, d̅_̅{̅t̅o̅B̅S̅}̅²̅ may refer to a square value of the average distance between the K head nodes and the base station node, K may refer to the number of clusters or head nodes, N may refer to the number of sensor nodes, and L may refer to a radius of the circular sensor field.

The deriving of the second function may include deriving the fourth energy, which is consumed by each of the N−K member nodes transmitting sensing data to the head node, as a fourth energy function with K as a variable based on Equation 4 below:

$$\{ \begin{matrix}{E}_{non - CH} = {\sum }_{i = 1}^{N - K} {E}_{i , non - CH} = ( N - K ) * {l}_{d} * ( {E}_{e} + {ε}_{f} * \overline{{d}_{toCH}^{2}} ) \\ \overline{{d}_{toCH}^{2}} = \frac{{L}^{2}}{k}\end{matrix} \qquad [ Equation 4 ]$$

E_{non-CH} may refer to the second function, E_{i,non-CH} may refer to an energy consumed by the member nodes belonging to the i^{th} cluster, la may refer to a bit length of the sensing data, Eₑ may refer to a preset first value, ε_{f} may refer to a preset second value, d̅_̅{̅t̅o̅C̅H̅}̅²̅ may refer to a square value of the average distance between the K head nodes and N−K member nodes, K may refer to the number of clusters or head nodes, N may refer to the number of sensor nodes, and L may refer to a radius of the circular sensor field.

The calculating of the value of K may include differentiating the third function by K to calculate the value of K as a solution to the pole, based on Equation 5 below:

$$K = \sqrt{\frac{2 {ε}_{f} {NL}^{2}}{3 {ε}_{f} {L}^{2} - 2 {E}_{e}}} \qquad [ Equation 5 ]$$

K may refer to the number of clusters, Eₑ may refer to a preset first value, ε_{f} may refer to a preset second value, N may refer to the number of sensor nodes, and L may refer to a radius of the circular sensor field.

The value of K may be determined based on the pole that minimizes the third function, which is derived by adding the first function and the second function.

The method for determining variables in routing based on deterministic cluster may further include determining the formation of the cluster region after the calculating of the value of K, wherein the determining of the formation of the cluster region may include arranging K congruent circles in an arbitrary region to minimize the diameter of the circle circumscribing the arbitrary region within the circular sensor field, and dividing the cluster region into the K regions based on the positions of the K congruent circles.

### Effects of the Invention

The disclosed embodiments may determine the number of clusters and the formation of clusters that minimize energy consumed by K head nodes and N−K member nodes in routing based on deterministic cluster.

The disclosed embodiments may extend the lifespan of wireless network sensors by determining the optimum number of clusters and the formation of clusters to minimize energy in routing based on deterministic cluster.

### BRIEF DESCRIPTION OF DRAWINGS

FIG. 1 is an example diagram illustrating a routing environment based on deterministic cluster, according to an embodiment.

FIG. 2 is a flowchart illustrating a method for determining variables in routing based on deterministic cluster, according to an embodiment.

FIG. 3 is a graph comparing the performance of methods for determining variables in routing based on deterministic cluster with respect to the number of clusters, according to an embodiment.

FIG. 4 is an example diagram illustrating a method for determining variables in routing based on deterministic cluster with respect to the formation of clusters, according to an embodiment.

FIG. 5 is a diagram comparing the performance of methods for determining variables in routing based on deterministic cluster with respect to the formation of clusters, according to one embodiment.

### BEST MODE FOR CARRYING OUT THE INVENTION

### Term Definitions

In this specification, routing based on deterministic cluster may refer to a protocol for finding the optimum communication path without random variables while calculating the coordinates of all nodes in the sensor field.

In this specification, the circular sensor field to be divided into K cluster regions is not currently divided because the number of clusters is not determined, but it may be understood that the circular sensor field is divided into K cluster regions when the number of clusters is determined.

In this specification, a base station node may be a node that receives data aggregated by a head node and ultimately processes data received by each member node. The base station node is preferably located at the border of the circular sensor field to calculate the positions of the other nodes.

In this specification, the head node may refer to a node that exists in each cluster region and manages its multiple member nodes in a centralized manner, such as aggregating sensing data collected by the member nodes.

In this specification, it is desirable that the member nodes are evenly distributed in each cluster region since the member nodes have a one-to-many relationship with the head node. That is, when there are N sensor nodes, it is desirable for each cluster region to include 1 head node and N/K−1 member nodes.

In this specification, the number of clusters is the number of divisions to divide the sensor field into cluster regions.

In this specification, given the number of clusters, the formation of clusters which relates to how the sensor field is divided may refer to the arrangement of clusters.

In this specification, the following symbols may be defined as in Table 1.

TABLE 1

| | |
|---|---|
| N | Number of sensor nodes |
| K | Number of clusters |
| L | Radius of circular sensor field |
| l_{d} | Bit length of sensing data |
| Eₑ | Energy, which is consumed by circuits in wireless sensor network |
| ε_{f} | First energy attenuation coefficient |
| εₘ | Second energy attenuation coefficient |

### Description of Exemplary Embodiments of the Invention

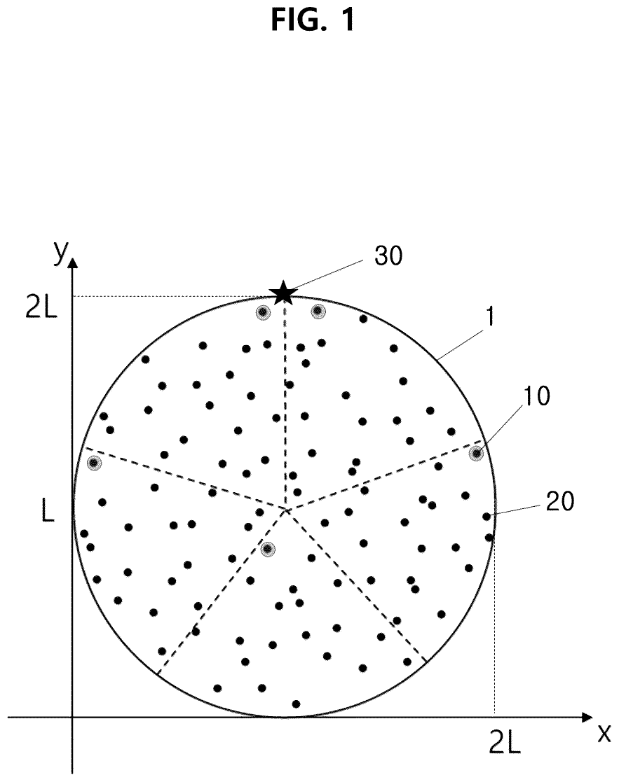

FIG. 1 is an example diagram illustrating a routing environment based on deterministic cluster, according to an embodiment.

A cluster-based wireless sensor network divides a sensor field into a plurality of cluster regions so that sensor nodes are evenly distributed in each of the cluster regions within the sensor field.

For example, as shown in FIG. 1, the cluster-based wireless sensor network may divide the sensor field into the plurality of cluster regions so that 100 sensor nodes are evenly distributed in each of 5 cluster regions, i.e., 20 sensor nodes are arranged in each cluster region.

In the cluster-based wireless sensor network, one head node is selected for each cluster, and the other sensor nodes than the head node become member nodes (20) within the cluster.

For example, as shown in FIG. 1, each of the 5 cluster regions may be divided to include 1 head node and the other 19 member nodes (20) than the head node.

Herein, in order to detect the locations of all nodes according to the definition of the wireless sensor network based on deterministic cluster, it is assumed that the sensor field is circular, and a base station node (30) is located at the border of the circular sensor field (1).

However, in FIG. 1, the number of clusters which is 5 and the formation of clusters which is a sector form are arbitrarily selected for convenience of explanation. The amount of energy consumed by the head node (10) and the member nodes (20) varies, depending on the number of clusters and the formation of clusters.

Hereinafter, the method for determining the number of clusters and the formation of clusters that maximize energy savings in routing based on deterministic cluster is described.

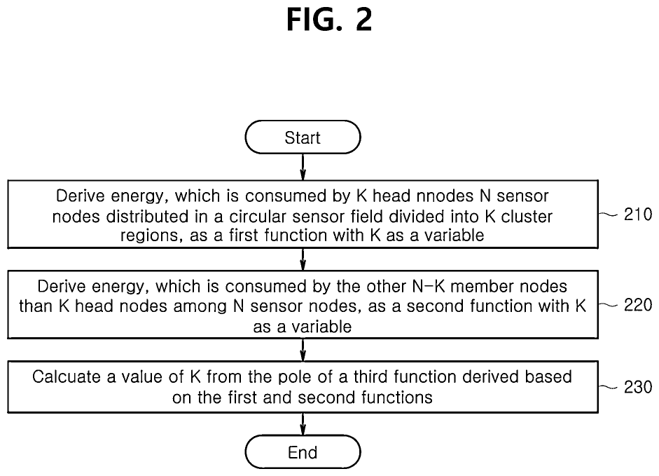

FIG. 2 is a flowchart illustrating a method for determining variables in routing based on deterministic cluster, according to an embodiment.

The method of FIG. 2 may be performed by a computing device capable of performing computation, or a sink node including a processor capable of performing computation, and a base station node (30).

For the convenience of explanation, the method of FIG. 2 is described as being performed by a sink node, but this is merely an example. The entity which performs the method of FIG. 2 is not limited to the examples listed above. The entity may be interpreted to include individual devices capable of computation and/or communication or combinations thereof.

First, the sink node derives the energy, which is consumed by K head nodes (10) among N sensor nodes distributed in the circular sensor field (1) divided into K cluster regions, as a first function with K as a variable.

The energy, which is consumed by the head node (10) for each cluster may be calculated according to the type of task.

First, the head node (10) may consume first energy by receiving sensing data from the member nodes (20).

For example, as shown in FIG. 1, one head node (10) belonging to the first cluster may receive sensing data from 19 member nodes (20) belonging to the first cluster. Similarly, one head node (10) belonging to the second cluster may receive sensing data from 19 member nodes (20) belonging to the second cluster. Accordingly, the head node (10) of each cluster may consume the first energy through the reception task.

It is desirable that the number of N sensor nodes be evenly distributed in each of the K cluster regions.

Accordingly, in the circular sensor field (1) divided into K cluster regions, K head nodes (10) may consume the first energy by receiving sensing data from N−K member nodes (20). The sink node may show a first function using the variable K for calculating the sum of the first energies.

Specifically, the sink node may derive the first energy, which is consumed by each of the K head nodes (10) receiving bit-unit sensing data from the member nodes (20), as a first function with K as a variable.

As an example, the sink node may show the first energy, which is consumed by each of the K head nodes (10), as a function with K as a variable based on Equation 1 below:

$${E}_{CH \_ E 1} = {\sum }_{i = 1}^{K} {E}_{i , CH \_ E 1} = K * {l}_{d} * ( \frac{N}{K} - 1 ) * {E}_{e} \qquad [ Equation 1 ]$$

E_{CH_E1}, which is a first energy function, may be calculated by multiplying E_{i,CH_E1}, which is the first energy consumed by the head node (10) of the i^{th} cluster, by the number K of the head nodes (10).

l_{d} may be a bit length in the sensing data. Eₑ, which is the amount of energy per bit inevitably consumed in the circuits when transmitting data, may be defined as a preset value. For example, Eₑ may have the amount of energy of 0.2 [nJ/bit] per bit when transmitting sensing data.

Second, the head node (10) may consume second energy by aggregating sensing data from the member nodes (20).

The sink node may derive the second energy, which is consumed by K head nodes (10) converting each sensing data into aggregate data, as a second energy function with K as a variable.

Specifically, the sink node may express the second energy consumed by each of the K head nodes (10) as a function with K as a variable based on Equation 2 below:

$${E}_{CH \_ E 2} = {\sum }_{i = 1}^{K} {E}_{i , {CH}_{E 2}} = {l}_{d} * {E}_{DA} * ( \frac{N}{K} ) \qquad [ Equation 2 ]$$

E_{CH_E2}, which is a second energy function, may be calculated by multiplying E_{i,CH_E2}, which is the second energy consumed by the head node (10) of the i^{th} cluster, by the number K of the head nodes (10).

l_{d} may be the bit length in the sensing data. E_{DA}, which is the amount of energy consumed by the head node (10) while processing sensing data, may be defined as a preset value. For example, E_{DA} may be a value determined in units of [J/bit/node] based on the amount of activity of the head node (10), the type of data, the bit length, and the like.

Third, the head node (10) may consume third energy by transmitting the processed aggregate data to the base station node (30).

The sink node may derive the third energy, which is consumed by each of K head nodes (10) transmitting aggregate data to the base station node (30) located at the border of the circular sensor field (1), as a third energy function with K as a variable.

Specifically, the sink node may express the third energy consumed by each of the K head nodes (10) as a function with K as a variable based on Equation 3 below:

$$\{ \begin{matrix}{E}_{CH \_ E 3} = {\sum }_{i = 1}^{K} {E}_{i , {CH}_{E 3}} = K * {l}_{d} * ( {E}_{e} + {ε}_{f} * \overline{{d}_{toBS}^{2}} ) \\ \overline{{d}_{toBS}^{2}} = \frac{3}{2} {L}^{2}\end{matrix} \qquad [ Equation 3 ]$$

E_{CH_E3}, which is a third energy function, may be calculated by multiplying E_{i,CH_E3}, which is the third energy consumed by the head node (10) of the i^{th} cluster, by the number K of the head nodes (10).

l_{d} may be the bit length in the sensing data. Eₑ, which is the amount of energy per each bit of aggregate data that is inevitably consumed in the circuits, may be defined as a preset value. For example, Eₑ, which is the amount of energy consumed per bit when transmitting aggregate data, may be 0.2 [nJ/bit]. ε_{f}, which is an energy attenuation coefficient in a free space model, may be 60 [pJ/bit/m2].

d̅_̅{̅t̅o̅B̅S̅}̅²̅, which is a square value of the average distance between the head node (10) of each cluster and the base station node (30), may be calculated based on Equation 4 below:

$$\overline{{d}_{toBS}^{2}} = \frac{1}{π {L}^{2}} {\int }_{2 L}^{0} 2 {x}^{3} {cos}^{- 1} ( \frac{x}{2 L} ) dx = \frac{3}{2} {L}^{2} \qquad [ Equation 4 ]$$

x is an integral variable and L is a length of the radius of the circular sensor field (1).

Equation 4 may refer to a formula used to obtain a mean square value of the distance from a point on the border of a circle with a radius L to an arbitrary point located inside the circle.

Afterwards, the sink node derives the energy, which is consumed by the other N−K member nodes (20) than the K head nodes (10) among the N sensor nodes, as a second function with K as a variable.

Specifically, the sink node may derive fourth energy, which is consumed by the N−K member nodes (20) each transmitting sensing data to the head node (10), as a fourth energy function with K as a variable based on Equation 5 below:

$$\{ \begin{matrix}{E}_{non - CH} = {\sum }_{i = 1}^{N - K} {E}_{i , non - CH} = ( N - K ) * {l}_{d} * ( {E}_{e} + {ε}_{f} * \overline{{d}_{toCH}^{2}} ) \\ \overline{{d}_{toCH}^{2}} = \frac{{L}^{2}}{k}\end{matrix} \qquad [ Equation 5 ]$$

E_{non-CH}, which is a second function, may be calculated by multiplying E_{i,non-CH}, which is the third energy consumed by each member node (20) belonging to the i^{th} cluster, by the number N−K of the member nodes (20). The overlapping descriptions shall be omitted.

d̅_̅{̅t̅o̅C̅H̅}̅²̅, which is a square value of the average distance between the member nodes (20) and the head node (10), may be calculated based on Equation 6 below:

$$[ Equation 6 ]$$

$$\overline{{d}_{toCH}^{2}} = \frac{1}{{π}^{2} {R}_{c}^{4}} {\int }_{0}^{2 π} {\int }_{0}^{{R}_{c}} {\int }_{0}^{2 π} {\int }_{0}^{{R}_{c}} [ {( {r}_{m} cos {θ}_{m} - {r}_{c} sin {θ}_{c} )}^{2} + {( {r}_{m} sin {θ}_{m} - {r}_{c} sin {θ}_{c} )}^{2} ] {r}_{m} {r}_{c} {dr}_{m} d {θ}_{m} {dr}_{c} d {θ}_{c} = {R}_{c}^{2} = \frac{{L}^{2}}{k}$$

rₘ and θₘ refer to variables expressing the coordinates of the member nodes (20) located randomly in the polar coordinate system. r_{c} and θ_{c} refer to variables expressing the coordinates of the head node (10) of the member nodes (20).

Since the lengths of rₘ and r_{c} have the following conditions, Equation 6 may have the same integration range as above:

$$0 \leq {r}_{m} \leq {R}_{c} \qquad [ Equation 6 ]$$

$$0 \leq {r}_{c} \leq {R}_{c}$$

R_{c} may be defined based on Equation 7 below:

$${R}_{c} = \frac{L}{\sqrt{K}} \qquad [ Equation 7 ]$$

Assuming that the cluster region is a circle with a length of radius R_{c}, R_{c} has a value of

$$\frac{L}{\sqrt{K}} .$$

This is because the sum of the areas of the K cluster regions is equal to the sum of the areas of the circular sensor field (1) with a length of radius L.

As the energy consumed by transmitting sensing data to another entity, the third energy function and the fourth energy function may be in the same direction.

For example, the third and fourth energy functions consumed by transmitting data to another entity may be defined as the energy consumed when transmitting 1 bit of data by a distance d based on Equation 8 below:

$${E}_{T} ( 1 , d ) = \{ \begin{matrix}l ( {E}_{e} + {ε}_{f} {d}^{2} ) , d < \sqrt{{ε}_{f} / {ε}_{m}} \\ l ( {E}_{e} + {ε}_{m} {d}^{4} ) , d \geq \sqrt{{ε}_{f} / {ε}_{m}}\end{matrix} \qquad [ Equation 8 ]$$

ε_{f} and εₘ, which are an energy attenuation coefficient in the free space model and an energy attenuation coefficient in the multipath model, may be 60 [pJ/bit/m 2] and 0.0013 [pJ/bit/m 4], respectively.

However, in this specification, the maximum length of any two nodes placed in the circular sensor field (1) is 2L and \sqrt{ε_{f}/εₘ} is 226.2 [m]. Assuming that the length of the radius is 100 [m] or less, the third and fourth energy functions are assumed to use the first equation of Equation 8.

Afterwards, the sink node calculates the value of K from poles of the third function derived based on the first function and the second function.

Specifically, the sink node may determine the minimum pole, derived by differentiating the third function derived by adding the first function to the second function with K, as the value of K.

That is, the sink node may differentiate the equation that sums up the first energy function, the second energy function, the third energy function, and the fourth energy function by K, and determine the minimum pole as the value of K.

In other words, the sink node may calculate the value of K in a closed form based on Equation 9 below:

$$K = \sqrt{\frac{2 {ε}_{f} {NL}^{2}}{3 {ε}_{f} {L}^{2} - 2 {E}_{e}}} \qquad [ Equation 9 ]$$

For convenience of explanation, description of overlapping symbols is omitted. As described above, L is preferably 100 [m] or less.

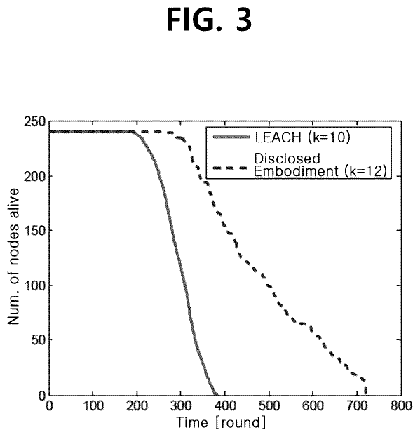

FIG. 3 is a graph comparing the performance of methods for determining variables in cluster-based routing with respect to the number of clusters, according to an embodiment.

FIG. 3 shows the lifespan of each routing method in terms of the number of sensor nodes operating with the remaining battery capacity.

When there are a total of 240 available sensor nodes and the lifespan of the routing method is a length of time until all sensor nodes are exhausted and cannot operate, it may be seen that the routing method significantly increases the lifespan, compared to the LEACH method which is an existing conventional technology.

FIG. 3 shows the result of the embodiment disclosed in a given environment when the optimum number of clusters is calculated as 12 and the result of the LEACH method disclosed in a given environment when the optimum number of clusters is calculated as 10.

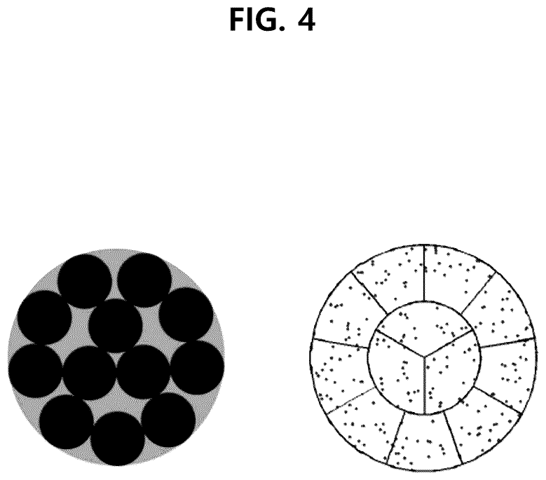

FIG. 4 is an example diagram illustrating a method for determining variables in routing based on deterministic cluster with respect to the formation of clusters, according to an embodiment.

Referring to FIG. 4, the sink node may determine the formation of the cluster regions after calculating a value of K.

The sink node may determine the formation of the cluster regions based on maximum dense packing of the circular sensor field (1).

The sink node may determine the formation of the cluster regions based on congruent circle-maximum dense packing of the circular sensor field (1).

The congruent circle-maximum dense packing refers to a method of packing a certain number of congruent members into a random circle as densely as possible.

Specifically, the congruent circle-maximum density packing may refer to a method of placing K congruent circles in an arbitrary region of a circular sensor field to minimize the size of the circle circumscribing the arbitrary region.

For example, the congruent circle-maximum density packing may refer to a method of placing K congruent circles, to minimize the size of the circle circumscribed by a region that has the entire perimeter of the K congruent circles as a silhouette, in the region.

The sink node may divide the cluster region using the arrangement structure of the congruent circles determined based on the maximum dense packing of congruent circles.

For example, when the number of clusters is set to 12, the congruent circles may be packed most densely as shown in FIG. 4 to minimize the size of the outer circle containing the 12 congruent circles.

The sink node may divide the cluster region based on the arrangement structure of the congruent circles.

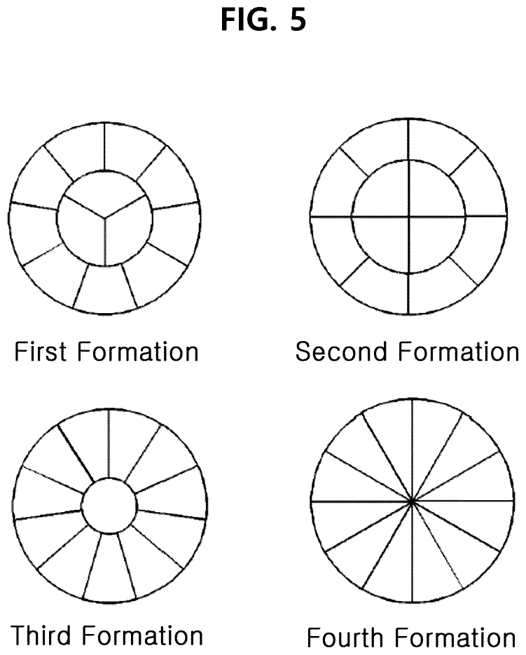

FIG. 5 is a diagram comparing the performance of methods for determining variables in routing based on deterministic cluster with respect to the formation of clusters, according to one embodiment.

When the number of clusters is determined to be 12, the area is the same but the shape and form of each cluster region may vary as shown in FIG. 5.

When the number of sensor modes is 240, the radius of the circular sensor field (1) is 87 m, and the optimum number of clusters is 12, the total amount of energy consumed by the head node (10) and member nodes (20) for each formation is shown as in Table 2 below:

TABLE 2

| | | Energy Consumption per |
|---|---|---|
| Formation of Clusters | Packing Density | Round |
| First Formation | 0.79 | 21.9 [mJ] |
| Second Formation | 0.69 | 22.3 [mJ] |
| Third Formation | 0.58 | 22.9 [mJ] |
| Fourth Formation | 0.51 | 27.2 [mJ] |

The first formation, which is determined according to the disclosed embodiment, has the highest packing density and the lowest energy consumption.

In other words, the lifespan of the wireless sensor network may be the longest in the same formation as the disclosed embodiment.

The afore-mentioned detailed description is provided to facilitate a comprehensive understanding of the methods described herein. However, this is only an example, and the present invention is not limited thereto.

In describing one embodiment, if it is determined that a detailed description of known technology related to the present invention unnecessarily obscures the gist of the embodiment, the detailed description thereof is omitted.

The terms used in this specification, which are defined in consideration of functions in the present invention, may vary depending on the intention or custom of the user or operator. Therefore, the definition shall be made based on the contents throughout this specification. The terms used in the detailed description are intended only to describe one embodiment and are not intended to be limiting.

Unless explicitly stated otherwise, singular forms include plural meanings.

Although representative embodiments of the present invention have been described in detail above, those skilled in the art will understand that various modifications can be made to the above-described embodiments without departing from the scope of the present invention. Therefore, the scope of the present invention shall not be limited to the described embodiments but shall be determined not only by the claims described below but also by equivalents to these claims.

### DESCRIPTION OF SYMBOLS

1: Circular Sensor Field
10: Head Node
20: Member Nodes
30: Base Station Node

1. A method for determining variable in routing based on deterministic cluster, the method comprising:
deriving energy, which is consumed by K head nodes among N sensor nodes distributed in a circular sensor field divided into K cluster regions, as a first function with K as a variable;
deriving energy, which is consumed by the other N−K member nodes than the K head node among the N sensor nodes, as a second function with the K as a variable; and
calculating a value of K from poles of a third function derived based on the first function and the second function.

2. The method of claim 1, wherein the N sensor nodes are evenly distributed in each of the K cluster regions.

3. The method of claim 1, wherein the deriving of the first function comprises:
deriving first energy, which is consumed by each of the K head nodes receiving sensing data from the N−K member nodes, as a first energy function with K as a variable;
deriving second energy, which is consumed by each of the K head nodes converting the sensing data into the aggregate data, as a second energy function with K as a variable;
deriving third energy, which is consumed by each of the K head nodes transmitting the aggregate data to a base station node located at the border of the circular sensor field, as a third energy function with K as a variable; and
deriving the first function by adding the first energy function, the second energy function, and the third energy function.

4. The method of claim 3, wherein the deriving of the first energy function comprises deriving the first energy, which is consumed by each of the K head nodes receiving bit-unit sensing data from the member nodes, as the first energy function based on the following Equation 1:
$${E}_{CH \_ E 1} = {\sum }_{i = 1}^{K} {E}_{i , CH \_ E 1} = K * {l}_{d} * ( \frac{N}{K} - 1 ) * {E}_{e} \qquad [ Equation 1 ]$$
(E_{CH_E1} may refer to a first energy function, E_{i,CH_E1} may refer to a first energy consumed by the head node of the i^{th} cluster, l_{d} may refer to a bit length of the sensing data, Eₑ may refer to a preset value, K may refer to the number of clusters or head nodes, and N may refer to the number of sensor nodes.)

5. The method of claim 3, wherein the deriving of the second energy function comprises deriving the second energy, which is consumed by each of the K head nodes converting the sensing data into the aggregate data, as a second energy function based on Equation 2 below:
$${E}_{CH \_ E 2} = {\sum }_{i = 1}^{K} {E}_{i , CH \_ E 2} = {l}_{d} * {E}_{DA} * ( \frac{N}{K} ) \qquad [ Equation 2 ]$$
(E_{CH_E2} may refer to a second energy function, E_{i,CH_E2} may refer to a second energy consumed by the head node of the i^{th} cluster, l_{d} may refer to a bit length of the sensing data, E_{DA} may refer to a preset value, K may refer to the number of clusters or head nodes, and N may refer to the number of sensor nodes.)

6. The method of claim 3, wherein the deriving of the third energy function comprises deriving the third energy, which is consumed by each of the K head nodes transmitting the aggregate data to the base station node located at the border of the circular sensor field, as a third energy function based on Equation 3 below:
$$\{ \begin{matrix}{E}_{CH \_ E 3} = {\sum }_{i = 1}^{K} {E}_{i , CH \_ E 3} = K * {l}_{d} * ( {E}_{e} + {ε}_{f} * \overline{{d}_{toBS}^{2}} ) \\ \overline{{d}_{toBS}^{2}} = \frac{3}{2} {L}^{2}\end{matrix} \qquad [ Equation 3 ]$$
(E_{CH_E3} may refer to a third energy function, E_{i,CH_E3} may refer to a third energy consumed by the head node of the i^{th} cluster, l_{d} may refer to a bit length of the sensing data, Eₑ may refer to a preset first value, ε_{f} may refer to a preset second value, d̅_̅{̅t̅o̅B̅S̅}̅²̅ may refer to a square value of the average distance between the K head nodes and base station node, K may refer to the number of clusters or head nodes, N may refer to the number of sensor nodes, and L may refer to a radius of the circular sensor field.)

7. The method of claim 1, wherein the deriving of the second function comprises deriving the fourth energy, which is consumed by the N−K member nodes transmitting sensing data to the head node, as a fourth energy function with K as a variable based on Equation 4 below:
$$\{ \begin{matrix}{E}_{CH \_ E 3} = {\sum }_{i = 1}^{K} {E}_{i , CH \_ E 3} = K * {l}_{d} * ( {E}_{e} + {ε}_{f} * \overline{{d}_{toCH}^{2}} ) \\ \overline{{d}_{toCH}^{2}} = \frac{{L}^{2}}{k}\end{matrix} \qquad [ Equation 4 ]$$
(E_{non-CH} may refer to a second function, E_{i,non-CH} may refer to an energy consumed by the member node belonging to the i^{th} cluster, l_{d} may refer to a bit length of the sensing data, Eₑ may refer to a preset first value, ε_{f} may refer to a preset second value, d̅_̅{̅t̅o̅C̅H̅}̅²̅ may refer to a square value of the average distance between the K head nodes and N−K member nodes, K may refer to the number of clusters or head nodes, N may refer to the number of sensor nodes, and L may refer to a radius of the circular sensor field.)

8. The method of claim 1, wherein the calculating of the value of K comprises differentiating the third function by K to calculate the value of K as a solution to the pole, based on Equation 5 below:
$$K = \sqrt{\frac{2 {ε}_{f} {NL}^{2}}{3 {ε}_{f} {L}^{2} - 2 {E}_{e}}} \qquad [ Equation 5 ]$$
(K may refer to the number of clusters, Eₑ may refer to a preset first value, ε_{f} may refer to a preset second value, N may refer to the number of sensor nodes, and L may refer to a radius of the circular sensor field.)

9. The method of claim 1, wherein the value of K is determined based on the pole that minimizes the third function, where the third function is derived by adding the first function and the second function.

10. The method of claim 1, wherein the method for determining variables in routing based on deterministic cluster further comprises determining the formation of the cluster region after the calculating of the value of K, wherein the determining of the formation of the cluster region comprises arranging K congruent circles in an arbitrary region to minimize the diameter of the circle circumscribing the arbitrary region within the circular sensor field, and dividing the cluster region into the K regions based on the positions of the K congruent circles.
